(19) United States
(12) Patent Application Publication
(10) Pub. No.: US 2009/0287473 A1
(43) Pub. Date: Nov. 19, 2009

(54) Method for Distributing Translated Resources from a Unified Source

(75) Inventors: Brendan Clarke Bull, Durham, NC (US); Jordan Thomas Liggitt, Cary, NC (US); Hirenkumar Ishvarbhai Patel, Durham, NC (US)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/120,835

(22) Filed: May 15, 2008

(51) Int. Cl. G06F 17/20

(52) U.S. Cl. 704/8

(57) ABSTRACT

A computer implemented method for distributing translated resources from a unified source involves collecting a plurality of translatable resources in differing format and/or file type and creating a unique key for each translatable resource that contains information about the type and name of the translatable resource which is used to re-distribute the translated resources from a common translation format file to the address and in the format or file type indicated by the unique key after translation.

### BACKGROUND OF THE INVENTION

1. Field of the Invention

This invention relates to unifying translation technologies with different formats into one format for use by the developer.

2. Description of Background

When developing software, it is generally the case that the translation bundles for a project will not be centralized in one place. In some cases, the developer does not edit the resource bundle directly, but adds the resources through another interface that populates the bundle for the developer. In that case, the developer may not even be aware of the location of all of the developer's translatable resources. Presently, there are no known development environments that help the developer easily manage multiple translation bundles.

### SUMMARY OF THE INVENTION

The shortcomings of the prior art are overcome and additional advantages are provided through the provision of a system that can unify all resources into one place for translation, and then distribute the translated resources into the appropriate place in the developer's workspace. For a developer using a tool where he or she is not keenly aware of where translatable text goes, the system for embodiments of the invention allows the developer to deal with one known file.

Embodiments of the invention propose a computer implemented method for distributing translated resources from a unified source involves collecting a plurality of translatable resources differing in format and/or file type (i.e., differing in component type and name), creating a unique key by a global key mapper for each of the plurality of translatable resources that indicates a component type and name for each translatable resource to ensure that a correct translated resource is generated for the translatable resource. The unique keys and translatable resources are bundled into a common translation format file and exported by a common format exporter for translation from one human language to another.

After translation, the translated resources bundled in the common translation format file are imported by a common format importer, and the global key mapper determines from the unique key the component type and name for each translatable resource to which the unique key belongs and in what format or file type the translated resource should be generated, whereupon each of the translated resources is generated and distributed to the address and in the format or file type indicated by the component type and name of the translated resource from the unique key.

### TECHNICAL EFFECTS

As a result of the summarized invention, technically we have achieved a solution for implementing a method for distributing translated resources from a unified source in which translatable resources are gathered and unique keys are generated by a global key mapper for each resource which include information about the type and name of the resource that can later be used to re-distribute the translated resources from a common translation file format after translation.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of the appearance of a ‘Application Basics’ software solution creation interface for embodiments of the invention;

FIG. 2 illustrates an example of the location at which the translated resources collected by the software solution creation interface reside for embodiments of the invention;

FIG. 3 illustrates an example of an ‘Add Variable’ software solution creation interface for embodiments of the invention;

FIG. 4 illustrates an example of the location at which the installation location text is placed by the software solution creation interface for embodiments of the invention;

FIG. 5 illustrates an example of a ‘Generate Base Resource Bundle’ interface for embodiments of the invention;

FIG. 6 illustrates an example of the appearance of the unified bundle generated for embodiments of the invention;

FIG. 7 is a flow chart that illustrates an example of the export mechanism for embodiments of the invention; and

FIG. 8 is a flow chart that illustrates an example of the import mechanism for embodiments of the invention.

The detailed description explains the preferred embodiments of the invention, together with advantages and features, by way of example with reference to the drawings.

### DETAILED DESCRIPTION OF THE INVENTION

The inventor herein has recognized that embodiments of the invention can be implemented, for example, in a tool, such as a software solution creation interface. Embodiments of the invention are built on top of existing components in the development environment. Some of these components are more complicated than what may be desirable to expose to a typical end user and are therefore masked. In many cases, resources collected in the high level interface must be translated (e.g., from one human language to another), and each of these components has a different way of performing translation.

A question arises as to how to expose translations to the developer in a sensible way. It is not sensible to present the developer, e.g., with ten different files in different formats, all with resources that the developer has never previously seen because the resources have been hidden from the developer. In the interface that is presented to the developer, the developer enters translatable strings that will show up in some other user interface (UI) at a later time.

The developer enters the translatable strings in various places and, depending on where they are entered, the translatable strings are mapped to an underlying file, and it is likely that the formats will be different. For example, in one case, the format may be an XML file where the tag indicates a key, and in another case, the format may be a property file. Embodiments of the invention build on top of a mixture of components that are so dissimilar, it is considered to be unacceptable to present the mixture to a user.

In an example embodiment, translatable resources are stored in one of three places, namely:

1) The project level properties file

2) Application level xml files

3) Solution level xml files

It is not feasible to simply store resources in a uniform location to begin with because the tool for embodiments of the invention is built on top of existing technology that has its own translation strategy. The developer cannot change the existing technology, but instead must work with the existing technology. This problem is likely to become quite common as componentization becomes more common, or for any tool that wraps different technologies into one interface.

Regardless of the precise nature of each of such resources, suffice it to say that the properties file and xml files do not have the same format or even the same encoding as such resources. Further, the tool hides these files from the developer. Requiring the developer to translate multiple files into multiple different languages and distribute them into the appropriate place with the correct encoding would increase the risk of error significantly at the very least.

Embodiments of the invention take all of those different translatable resources in different formats that were previously masked and hidden from the developer and pull them out into a common format and rename them with unique names so that it is known where they came from and in what format they need to be after translation. Examples of the different formats include property files which are simply e-value pairs, XML files for which a tag name indicates the key and the element text indicates the actual translatable value, and JAVA property files which were basically JAVA source files with keys and value specified in JAVA code. It is to be understood, however, that embodiments of the invention include any other suitable formats.

Depending upon the origin and nature of a translatable resource, the translatable resource has a component type and a component name. Embodiments of the invention involve generation of a globally unique key which includes information about the component type and name (i.e. from where it came). Thus, when the translated version of a file is received, it can be mapped back into its appropriate format and at the appropriate location based on the information in the key.

In embodiments of the invention, the translatable resources together with their respective keys are gathered into a common format, e.g., a property file, which is a text file with a specialized format that is a standard format for translations and resource bundles. The user is then prompted to ship the file off to translation, and when the file for the translated resources is returned, it can be imported back into the interface.

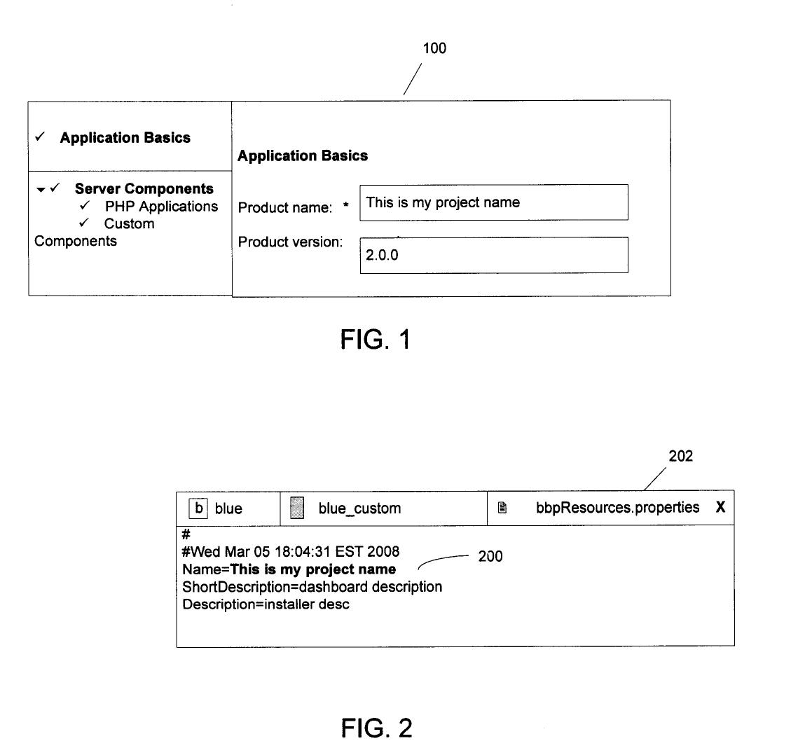

With regard to project level properties, FIG. 1 illustrates an example of the appearance of an ‘Application Basics’ software solution creation interface 100 for embodiments of the invention. FIG. 2 illustrates an example of location at which the translated resources collected by the software solution creation interface reside for embodiments of the invention. Referring to FIGS. 1 and 2, the project name 200 is an example of a project level resource, which the interface 100 places into a properties file 202 of which the user is not aware.

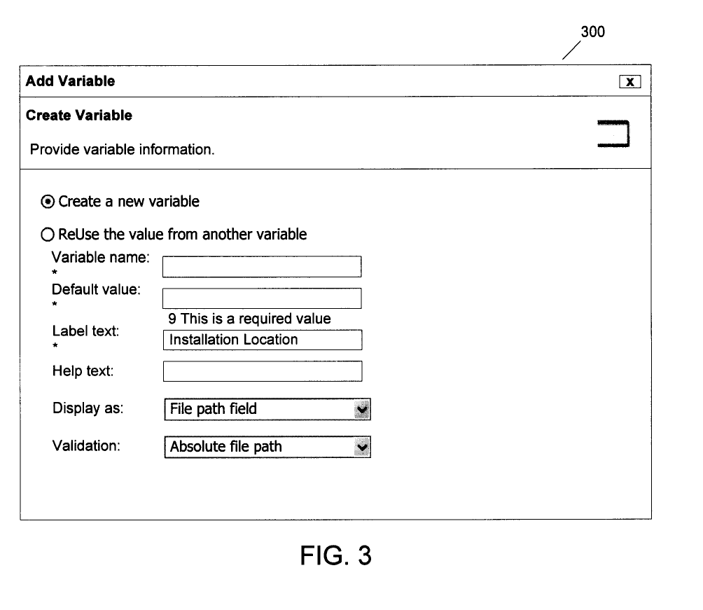

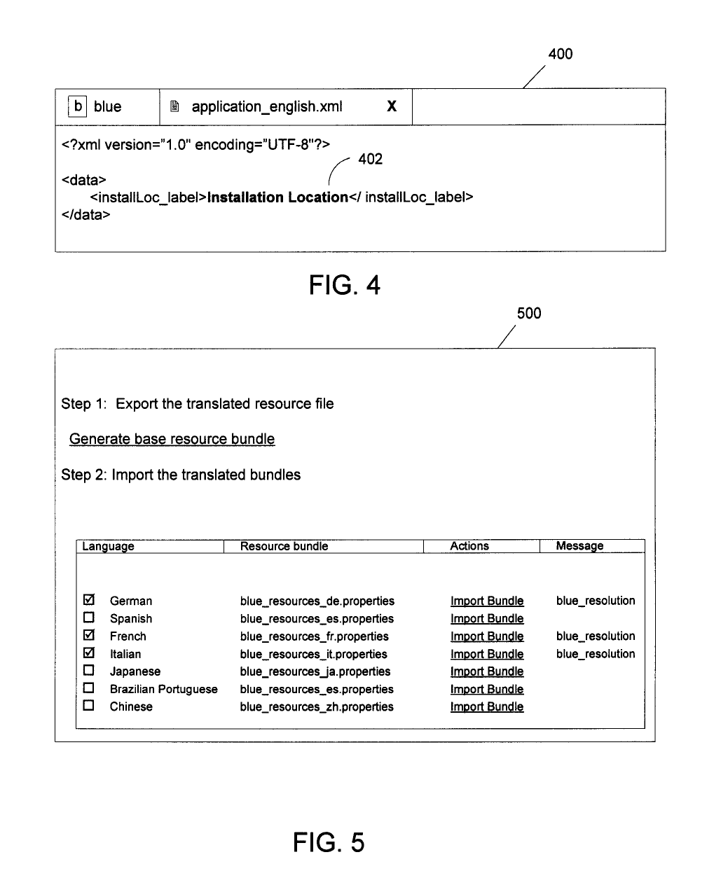

Application level properties are resources which are description text for application components that will be installed as part of the overall solution that is being created. FIG. 3 illustrates an example of an ‘Add Variable’ software solution creation interface 300 for embodiments of the invention. FIG. 4 illustrates an example of the location 400 at which the installation location text 402 is placed by the software solution creation interface 100 for embodiments of the invention. Likewise, the installation location text 402 is placed in a location that is hidden from the user. It is to be noted that in the example, the format and file type are different. It is to be further noted, for example, that there can be many “application_english.xml” files for a given project. The more application components there are, the more difficult it is to manage development of the software.

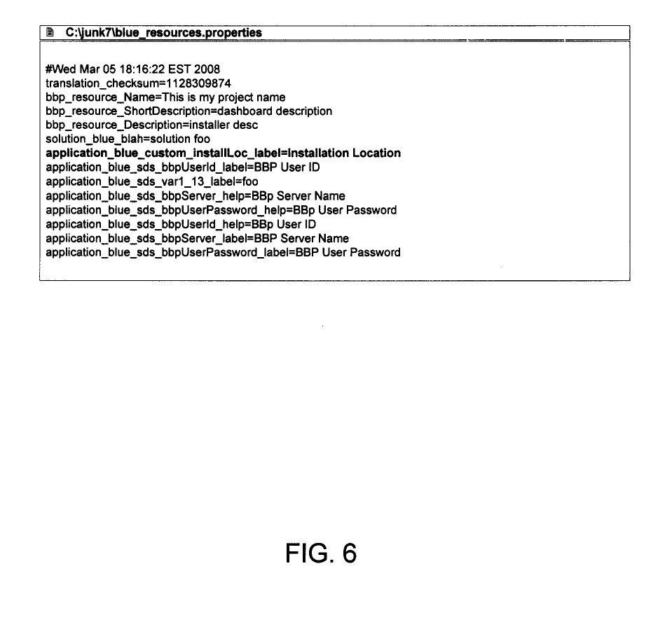

A solution provided by embodiments of the invention gives the user a way to export a unified translation bundle that collects all of the resources for the user into one properties file of the correct encoding. FIG. 5 illustrates an example of a ‘Generate Base Resource Bundle’ interface 500 for embodiments of the invention. FIG. 6 illustrates an example of the appearance of the unified bundle generated for embodiments of the invention.

Referring to FIG. 6, note that the keys have been modified which ensures that there are no naming collisions from the various components and that an address is available for use in redistributing the resources when the translated unified bundles are imported. On import, the tool for embodiments of the invention intelligently distributes the resources to the appropriate locations in the correct encoding, and the developer is required to see only a single unified file. This approach can be implemented in any development environment.

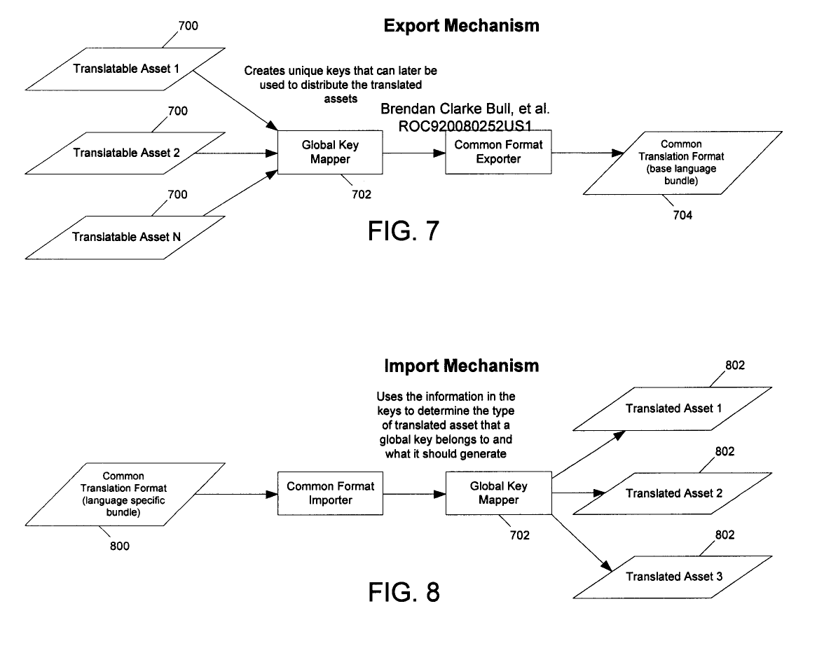

FIG. 7 is a flow chart that illustrates an example of the export mechanism for embodiments of the invention, and FIG. 8 is a flow chart that illustrates an example of the import mechanism for embodiments of the invention. Referring to FIG. 7, at export time, the translatable resources 700 are gathered, and unique keys are generated at the global key mapper 702 for each resource which can later be used to distribute the translated assets. These unique keys contain the following information:
1) The kind of translated resource from which the particular translatable resource came.
2) The manner in which the information should be recreated when the translated resources are re-imported
   These unique keys are put into a common translation format (base language bundle) file 704 that is shipped for translation.

At import time, embodiments of the invention perform distribution of translated resources 802 for the user, e.g., by scanning the file and determining to which component to distribute each resource based on the format and location information in the key. The format and location information is encoded in the key that was sent off with the translatable resource. The list of all the keys in the translated file is scanned and the translated resources are redistributed to all of the appropriate places.

Referring to FIG. 8, at import time after translation, the information contained in the keys in the common translation format (language specific bundle) file 800 is used by the global key mapper 702 to determine the type of translated asset to which a global key belongs and what it should generate to ensure that the correct translated resources 802 are generated.

For an example of a user perspective for embodiments of the invention, in response to a prompt to enter a product description in a ‘product description’ field, the user types in the product description. If the user wishes to have the user's product translated, the user can run an exporter for embodiments of the invention, which (transparent to the user) gathers all of the translatable resources 700 from all of the components, runs the translatable resources through the global key mapper 702, and generates a single file 704 that is all that the user sees. The user then sends that file 704 off to the user's translation center, e.g., as a ZIP file by email, where each resource 700 is translated from one natural (human) language to another. When the translated file 800 is returned to the user, the user can re-import the file into the development environment, whereupon the translated resources 802 are re-distributed to the appropriate locations in the appropriate formats.

The flow diagrams depicted herein are only examples. There may be many variations to these diagrams or the steps (or operations) described therein without departing from the spirit of the invention. For example, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A computer implemented method for distributing translated resources from a unified source, comprising:
a. creating a unique key by a global key mapper for each of a plurality of translatable resources in a plurality of different formats from a plurality of different locations, in which unique key is encoded format and location information for each of the translatable resources;
b. bundling the plurality of translatable resources together with the respective key for each of the translatable resources into a common translation format file and exporting the common file by a common format exporter for translation from one human language to another;
c. importing the common translation format file of translated resources together with the respective key for each of the resources by a common format importer after translation;
d. identifying from the unique key for each translated resource by the global key mapper the a format in which the translatable resource to which the unique key belongs is to be generated, and a location to which the translated resource is to be distributed, after translation; and
e. generating and distributing each of the translated resources in the format and to the location according to the format and location information of the translated resource identified by the global key mapper.
